(19) United States
(12) Patent Application Publication
(10) Pub. No.: US 2016/0032741 A1
(43) Pub. Date: Feb. 4, 2016

(54) SHOT PEENING DEFORMATION PROCESS FOR ASSEMBLING TWO PARTS OF A TURBOMACHINE

(71) Applicant: SNECMA, Paris (FR)

(72) Inventor: Alexis Perez-Duarte, Jurica (MX)

(73) Assignee: Snecma, Paris (FR)

(21) Appl. No.: 14/784,194

(22) PCT Filed: Apr. 17, 2014
(86) PCT No.: PCT/FR2014/050942

§ 371 Date: Oct. 13, 2015

(30) Foreign Application Priority Data
Apr. 18, 2013 (FR) 13 53534

(51) Int. Cl. F01D 9/02; B24C 1/10

(52) U.S. Cl. CPC F01D 9/02; B24C 1/10; F05D 2230/20

(57) ABSTRACT

The main object of the invention is a process for deforming at least one part (1, 2) of a turbomachine through shot peening for assembling a first turbomachine part (1) with a second turbomachine part (2), including the steps of defining at least one area (A) of said at least one part (1, 2) intended to be deformed, and of performing a shot peening operation (G) on said at least one area (A) in order to deform said at least one part (1, 2) and enable the first part (1) and the second part (2) to be assembled.

### TECHNICAL FIELD

The present invention relates to the field of turbomachines, and more particularly to the field of processes for deforming turbomachine parts, enabling in particular the parts to be assembled.

The invention applies to any type of land or air turbomachines, and especially airplane turbomachines such as turbojet and turboprops.

The invention thus relates more specifically to a process for deforming at least one part of a turbomachine through shot peening, as well as a turbomachine including a part deformed by implementing such a process.

### STATE OF PRIOR ART

As part of the development of turbomachine parts, especially, turbomachine rotary parts, manufacturing or assembling part to each other gives rise to problems in terms of implementing manufacturing or assembling processes, and of operating properties of parts due to significant loadings and this especially when the parts are made of different materials.

In particular, assembling a metal leading edge on a composite material core of a turbomachine vane blade is a known operation. The presence of a metal material leading edge is made necessary by the operating conditions of the blade, especially due to erosion phenomena. However, assembling a metal leading edge on the composite material core remains a complex operation to perform.

Conventionally, such an assembling is achieved by gluing, after adequately preparing the surfaces of the parts to be assembled together. Such an assembling operation through gluing is not satisfactory, since it does not enable in particular suitable mechanical properties and a sufficient securing of the parts to each other to be obtained.

Furthermore, for improving the mechanical properties of the surfaces of the turbomachine parts, for example for improving the resistance to fatigue and corrosion, the use of the shot peening process is known.

By way of examples, the international application WO 2007/137902 A1 describes a device for shot peening by beads a turbomachine blade shank. Further, the international application WO 2008/071162 A2 relates to a device used for hammering a component of a gas turbine using shot peening. Furthermore, the patent application FR 2 908 678 A1 describes a process for treating by ultrasound shot peening a part using a sonotrode projecting projectiles against the part.

Especially the shot peening process is a mechanical treatment intended to improve the mechanical properties of a metal part through surface hardening. It is based on the structural transformation of materials. The conventional process consists in placing the metal parts under superficial compression, by projecting small steel, glass, or ceramic beads. This microblasting operation creates a compressed area which is the site of inner compressive stresses through which resistance is increased.

The use of a shot peening process for improving the mechanical properties of turbomachine parts leads to several undesirable penalizing side effects, and especially the deformation of the parts induced by compression. For this reason, the shot peening process is conventionally used while trying to minimize at most its undesirable deformation effect on parts.

### DISCLOSURE OF THE INVENTION

There is thus a need for providing an alternative solution in order to enable turbomachine parts to be deformed, in particular to facilitate the manufacture or assembling of these parts.

The purpose of the invention is to overcome at least partially the abovementioned needs and the drawbacks related to the embodiments of prior art.

The purpose of the invention is thus, according to one of its aspects, a process for deforming at least one turbomachine part through shot peening for assembling a first turbomachine part with a second turbomachine part, including the steps of:

defining at least one area of said at least one part intended to be deformed,

performing a shot peening operation on said at least one area in order to deform said at least one part and enable the first part and the second part to be assembled.

Deforming the turbomachine part can thus advantageously enable the part to be assembled with another part.

Thanks to the invention, the shot peening process is advantageously implemented to enable at least one turbomachine part to be deformed. The deformation undergone by the part during shot peening is thus desired and exploited at best to enable its assembling.

The process according to the invention can further include one or more of the following features taken independently or according to any possible technical combinations.

The deformation undergone by the part during shot peening can enable its dimensions to be modified, such as for example its height, thickness, diameter.

Assembling through shot peening can be used alone to assemble the first and second parts, or even in combination with one or more known assembling solutions according to prior art, for example through gluing.

The first and second turbomachine parts can be made of different materials.

The first part can be disposed on either side of the second part. Then, during assembly, the shot peening operation consists in generating a mechanical strain for pinching the first part on the second part.

The first part can be made of a metal material, being especially constituted by the leading edge of a turbomachine blade vane. The second part can be made of a composite material, being especially constituted by the core of the turbomachine blade vane.

Furthermore, means for protecting said at least one part, especially the second part, can be placed on the surface thereof during the shot peening operation. The protecting means can for example enable a damage risk to a composite material part to be avoided.

The process can also include the step in which, prior to the shot peening operation, the parameters of the shot peening operation are determined as a function of the desired deformation, especially as a function of the assembly to perform between the first and second turbomachine parts.

One or more tools simulating shot peening operations can for example be used in the process according to the invention to provide the deformation of the part and define accordingly the parameters of the shot peening operation.

The process can further include, in addition to a step of assembling the first part and the second part through a mechanical holding means corresponding to the shot peening operation, a step of assembling the first part and the second part through an additional holding means.

The additional holding means can be an adhesive holding means, especially glue.

Furthermore, at least one of the first and second parts can include, on a portion located at said at least one area undergoing the shot peening operation, means for reinforcing the assembly of the first part and the second part.

The reinforcing means can include an adapted surface finish of the portion located at said at least one area undergoing the shot peening operation, especially an adapted roughness of said portion's surface.

The reinforcing means can further include two complementary hooking forms, especially male and female.

More particularly, the first part can include a first hooking form and the second part can include a second hooking form, the second hooking form being complementary to the first hooking form, the first and second complementary hooking forms cooperating together to hold mechanically the assembly of the first and second parts.

The object of the invention is also, according to another aspect, a turbomachine, characterized in that it includes at least one part deformed by implementing the process such as previously defined.

The turbomachine according to the invention can include any of the previously stated features, taken independently or according to any possible technical combinations with other features.

### BRIEF DESCRIPTION OF THE DRAWINGS

The invention will be better understood upon reading the following detailed description, an exemplary non-limiting implementation thereof, and upon examining the schematic partial figures of the accompanying drawings, on which:

FIG. 1 is a schematic perspective representation of two exemplary turbomachine parts intended to be deformed by implementing the process according to the invention,

FIGS. 2A, 2B, and 2C are cross-section representations of the two turbomachine parts of FIG. 1, respectively during the three steps of the process according to the invention to enable their assembly,

FIG. 3 is a cross-section illustration of the use of an additional adhesive holding means for assembling both turbomachine parts of FIG. 1,

FIGS. 4A and 4B are cross-section partial illustrations of the use of reinforcing means as a surface finish adapted for assembling both turbomachine parts of FIG. 1, and

FIGS. 5A and 5B are cross-section illustrations of the use of reinforcing means as complementary hooking forms for assembling both turbomachine parts of FIG. 1.

Throughout all these figures, identical reference numerals may refer to identical or analogous elements.

Furthermore, the different parts represented in the figures are not necessarily drawn to a uniform scale, in order to make the figures more understandable.

### DETAILED DISCLOSURE OF A PARTICULAR EMBODIMENT

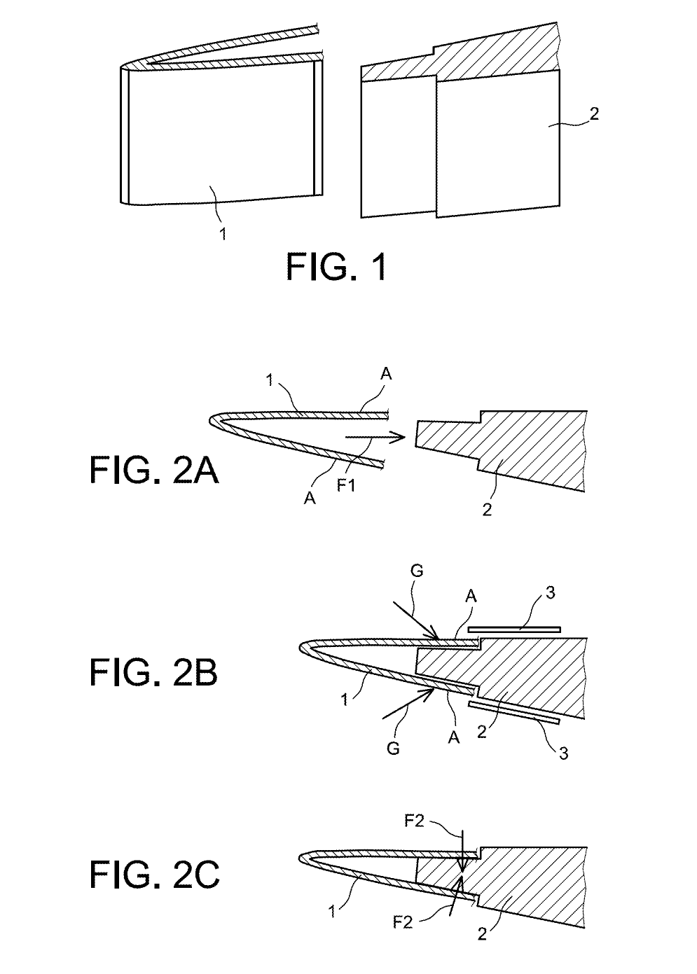

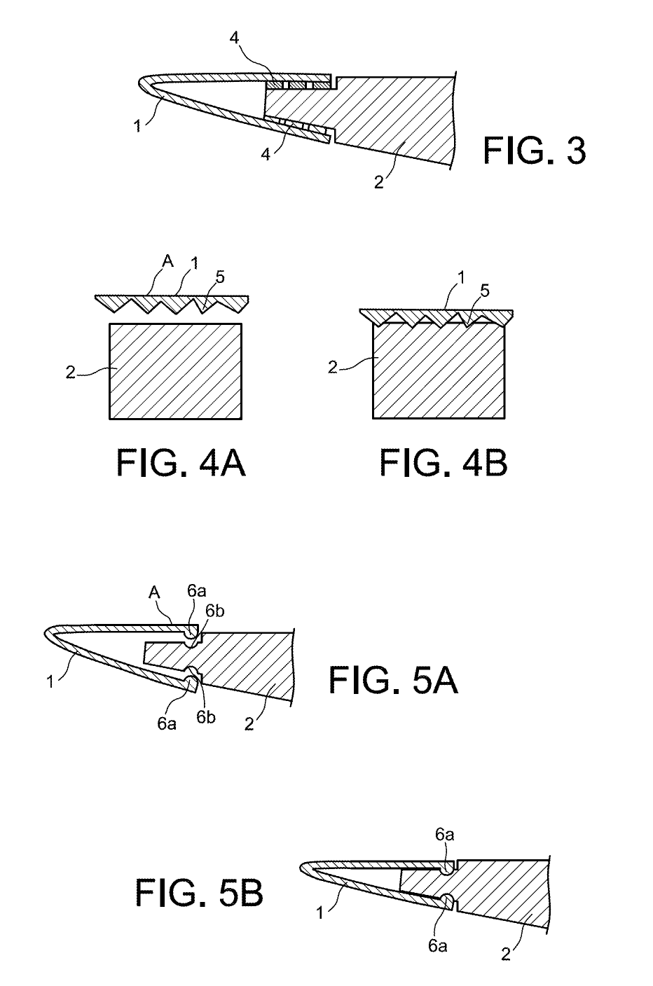

FIG. 1 and FIGS. 2A, 2B and 2C represent two exemplary turbomachine parts, intended to be deformed by implementing the process according to the invention. FIGS. 3, 4A-4B, and 5A-5B, latter described, illustrate various solutions enabling the reinforcement of the mechanical strength of the assembly of both turbomachine parts obtained through shot peening.

In this example, the process according to the invention is implemented to enable a first turbomachine part 1 to be assembled with a second turbomachine part 2.

FIG. 1 represents, in perspective and unassembled, the first part 1 and the second part 2.

The first 1 and second 2 turbomachine parts are, for example, intended to constitute a turbomachine blade vane. In particular, the first part 1 constitutes the metal leading edge of the vane and the second part 2 constitutes the composite material CMO core of the vane.

FIGS. 2A, 2B, and 2C successively illustrate the steps of assembling of the first part 1 and the second part 2, during the implementation of the process according to the invention.

In FIG. 2A, two areas A are defined on which shot peening operations G are performed in order to enable the deformation of at least the leading edge 1, intended to be assembled on the core 2, according to the arrow F1.

In FIG. 2B, shot peening operations G are performed on the areas A, which are previously defined on the leading edge 1, in order to enable the leading edge 1 to be assembled on the core 2.

Furthermore, protection means 3, placed for example at the junctions between the leading edge 1 and the core 2, are used in order to avoid any damage risk of the composite material core 2.

FIG. 2C represents the obtained deformation of at least the leading edge 1 on the core 2, after assembling both parts according to the process of the invention, with a resulting mechanical clamping according to the arrows F2.

In the above-described example, the shot peening operations G consist in generating a mechanical strain for pinching the metal material leading edge 1 on the composite material core 2, which mechanical strain is itself induced by compressing the flanks of the leading edge 1. Such a process for compressing the leading edge 1 surface also implicitly generates a benefit consisting in restricting the initiation and propagation of a surface crack.

To guarantee the assembly of both parts 1 and 2 to each other, the geometry, or even the surface finish of one part or both, can be adapted to enable a better behaviour of the parts, during the clamping assembly.

In reference to FIGS. 3, 4A-4B, and 5A-5B, various means for reinforcing the strength of the mechanical bond obtained through the shot peening G process for assembling the first 1 and second 2 parts together will now be described.

First, FIG. 3 is a cross-section illustration of the use of an additional adhesive holding means 4 for assembling the first 1 and second 2 parts. This additional adhesive holding means can for example be glue 4.

Thus, the second part 2 can be coated on either side with a layer of glue 4 before positioning the first part 1 on the latter, and performing the shot peening operation G.

The presence of such a glued bond at the interface between the first part 1 and the second part 2 can enable both parts 1 and 2 to be contacted, and especially the interface between the metal material of the first part 1 and the composite material of the second part 2, with a certain pressure and more homogenously. Thus, the following shot peening operation G to ensure a mechanical hold of both parts 1 and 2 may constitute a way of improving the strength of both parts 1 and 2, obtained by the glued bond. More precisely, the shot peening operation G enables the leading edge 1 surface to be brought back on the opposite core 2 face by inducing a reinforcement of the bonding.

Besides, FIGS. 4A-4B and 5A-5B are cross-section illustrations of the use of means for reinforcing 5, 6a, 6b the assembly of the first 1 and second 2 parts.

With reference to FIGS. 4A and 4B, which are partial since they only represent the region of the first 1 and second 2 parts intended to undergo the shot peening operation G, the reinforcing means correspond to an adapted surface finish 5 of the first part 1.

More particularly, the first part 1 includes a surface intended to contact the second part 2, which has a geometrical adaptation at the interface formed with the second part 2 in order to reinforce the strength of the assembly.

Thus, the surface of the first part 1 is for example rough, as illustrated in FIG. 4A. Having a surface with a certain roughness can enable the first part 1 to be partially pushed into the second part 2 during the shot peening operation G, as illustrated in FIG. 4B. More particularly, the metal material of the leading edge 1 having a hardness greater than that of the composite material of the core 2, the roughness peaks of the adapted surface finish 5 of the first part 1 get inlaid in the core 2 during the deformation of the leading edge 1 through shot peening G, which introduces a hooking effect improving the strength of the assembly.

However, this hooking effect may require a certain mastery during shot peening G in order to avoid in particular damaging the composite material of the core 2. Thus, if need be, the second part 2 can be coated with a protecting hooking layer, also referred to as “sacrificial” layer, for example glue or another coating, intended to enable the micro penetration of the roughness peaks of the adapted surface finish 5 of the first part 1 and to avoid, or at least restrict, damaging the second part 2.

With reference to FIGS. 5A and 5B, the reinforcing means moreover correspond to complementary hooking forms 6a and 6b for assembling both parts 1 and 2.

More precisely, the first part 1 includes first hooking forms 6a, for example as overlaps, constituting male hooking forms 6a, and the second part 2 includes second hooking forms 6b, for example as recesses, constituting female hooking forms 6b. These hooking forms 6a and 6b can be obtained for example by machining the first 1 and second 2 parts.

Advantageously, the male hooking forms 6a and the female hooking forms 6b are complementary, so as to enable a penetration into one another during the shot peening operation G, as illustrated in FIG. 5B. This way, a “mechanical lock” is obtained, which enables the assembling obtained through shot peening G of the first 1 and second 2 parts to be further reinforced.

Thus, more generally, the metal material leading edge 1 can be shot peened on the composite material core 2 thanks to a complementarity of the surface finishes of both parts 1 and 2.

Of course, the invention is not limited to the exemplary embodiment which has just been described, various modifications can be brought thereto by those skilled in the art.

The expression “including one/a/an” must be understood as being a synonym of “including at least one”, unless otherwise specified.

What is claimed is:

1-15. (canceled)

16. A shot peening deformation process for at least one part of a turbomachine for assembling a first part of a turbomachine with a second part of a turbomachine, including the steps of:
defining at least one area of said at least one part intended to be deformed,
performing a shot peening operation on said at least one area in order to deform said at least one part and enable the first part and the second part to be assembled.

17. The process according to claim 16, wherein the first and second parts of a turbomachine are made of different materials.

18. The process according to claim 16, wherein the first part is disposed on either side of the second part.

19. The process according to claim 18, wherein, during assembly, the shot peening operation consists in generating a mechanical stress for pinching the first part on the second part.

20. The process according to claim 16, wherein the first part is made of a metal material, being constituted by the leading edge of a turbomachine blade vane, and wherein the second part is made of a composite material, being constituted by the core of the turbomachine blade vane.

21. The process according to any of claim 16, wherein means for protecting said at least one part placed on the surface thereof during the shot peening operation.

22. The process according to claim 16, wherein it includes the step in which, prior to the shot peening operation, the parameters of the shot peening operation are determined as a function of the assembly to perform between the first and second parts of a turbomachine.

23. The process according to claim 16, wherein one or more tools for simulating shot peening operations are used to provide the deformation of said at least one part and to define the parameters of the shot peening operation.

24. The process according to claim 16, wherein it includes, in addition to a step of assembling the first part and the second part through a mechanical holding means corresponding to the shot peening operation, a step of assembling the first part and the second part through an additional holding means.

25. The process according to claim 24, wherein the additional holding means is an adhesive holding means.

26. The process according to claim 16, wherein at least one of the first and second parts includes, on a portion located at said at least one area undergoing the shot peening operation, means for reinforcing the assembly of the first part and the second part.

27. The process according to claim 26, wherein the reinforcing means include an adapted surface finish of the portion located at said at least one area undergoing the shot peening operation.

28. The process according to claim 26, wherein the reinforcing means include two complementary hooking forms.

29. The process according to claim 28, wherein the first part includes a first hooking form and wherein the second part includes a second hooking form, the second hooking form being complementary to the first hooking form, the first and second complementary hooking forms cooperating together to mechanically hold the assembly of the first and second parts.

30. A turbomachine, including at least one part deformed by implementing the process according to claim 16.
